(19) United States
(12) Patent Application Publication
(10) Pub. No.: US 2011/0180354 A1
(43) Pub. Date: Jul. 28, 2011

(54) Disc Brake

(76) Inventors: Lothar Wagner, Steinefrenz (DE); Jon Wemple, Royal Oak, MI (US); Xiongsheng Zhang, Shanghai (CN)

(21) Appl. No.: 12/992,364

(22) PCT Filed: May 18, 2009
(86) PCT No.: PCT/EP09/03522

§ 371 Date: Jan. 27, 2011

(51) Int. Cl. F16D 55/226; B23P 11/00

(52) U.S. Cl. 188/71.1; 29/525.11

(57) ABSTRACT

A disc brake for motor vehicle is discussed, which is of a simple design, comprises few parts, requires few machines for its manufacture and is low-noise and easy to assemble. For this purpose, the brake anchor plate receives in the receiving eyes retaining bolts which in turn support the brake linings. The floating caliper is connected by springs and through-points to the lining carriers.

### CROSS-REFERENCE TO RELATED APPLICATIONS

This application is a national stage of International Application No. PCT/EP2009/003522 filed May 18, 2009, the disclosures of which are incorporated herein by reference in entirety, and which claimed priority to China Patent Application No. 200810037560.9 filed May 16, 2008, the disclosures of which are incorporated herein by reference in entirety, and to German Patent Application No. 10 2008 029 044.0 filed Jun. 18, 2008, the disclosures of which are incorporated herein by reference in entirety.

### BACKGROUND OF THE INVENTION

The invention relates to a disc brake for motor vehicles, in particular to a floating-caliper partially lined disc brake.

In the case of conventional disc brakes currently used in large numbers in motor vehicle construction, the brake linings are guided and supported in the well of the brake anchor plate or in the well of the brake housing against mostly planar surfaces that extend parallel to one another. These surfaces are produced by machining the brake anchor plate or the brake housing generally by broaching by means of broaching tools. Broaching tools are very expensive tools and each has to be manufactured individually tuned to the well dimensions of the brake parts that are to be machined. If brake linings having different dimensions in their tangential extent are used for the various brakes, a separate broaching tool has to be manufactured for each one of these brakes.

Whereas in disc brakes of the fixed-caliper style of construction the outer housing half is screw-connected to the inner housing half, and the inner housing half has screw-on eyes for fastening the disc brake to the stub axle, in the case of a floating-caliper partially lined disc brake the floating caliper is mostly guided and supported on guide pins. These guide pins may be screw-connected to the brake anchor plate, in which case the guidance is effected in bores of the floating caliper, or they are screw-fastened to eyes of the floating caliper, in which case the guidance is effected in bores of the brake anchor plate. The guide pins and the guide bores are conventionally sealed off to prevent damage as a result of dirt and moisture.

From the German patent specification DE 1 070 048 a partially lined disc brake is known, in which axially displaceable lining carriers are disposed on both sides of the brake disc. Pins extend from the outer lining carrier through the brake disc. The pins are supported in bushes in the lining carrier. They are connected by their ends to a bow. The inner lining carrier with bush-like through-points embraces the pins and is therefore guided on the pins. The inner lining carrier is moreover coupled to an actuating cylinder.

The brake anchor plate takes the form of a—viewed in axial direction—narrow receiving eye in the region of receiving the bushes. The brake application force of the actuating cylinder is transmitted to the outer lining carrier via the bow and the pins. The brake application force of the outer brake lining is then transmitted from the tangential ends of the lining carrier into the friction mass.

In order to keep the bending losses low, the large tangential distance of the point of introduction of the brake application force from the area centre of gravity of the friction mass necessitates a large axial extent of the lining carrier. This in turn precludes a conventional, approximately five millimetre thick, steel, planar carrier plate.

A further partially lined disc brake is known from the German patent specification DE 1 006 735. In this construction, two claw-like bows embrace the outer lining carrier and two angle levers coupled to the inner lining carrier. These bows transmit the brake application force to the outer lining carrier. By virtue of the two claw-like bows the force introduction points may be selected in a way that allows the axial extent of the lining carrier to be reduced in relation to the construction according to the patent specification DE 1 070 048.

From the German patent specification DE 1 505 491 and its patent family, U.S. Pat. No. 3,298,468, U.S. Pat. No. 3,406,792, a floating-caliper partially lined disc brake is known, which is fastened directly to receiving eyes of a stub axle. A conventional brake anchor plate is consequently not applicable. The axial centre of the receiving eyes of the stub axle coincides with the axial centre of the friction rim of the brake disc. Two pins penetrate these receiving eyes of the brake anchor plate. Two brake linings with the receiving eyes of the lining carrier embrace these pins with ample clearance, such that the linings are pulled upon frictional engagement with the brake disc. The floating caliper is divided in two. The bridge and the cylinder housing are connected by screws. The floating caliper is guided and supported on pins. These pins in turn are supported in bores of the lining carriers. These pins may, according to U.S. Pat. No. 3,406,792, be supported in durable resilient bushes.

From the German utility model DE 85 19 567 and its patent family, U.S. Pat. No. 4,944,371, a floating-caliper partially lined disc brake is known, in which the two-part floating caliper is screw-fastened—viewed in peripheral direction—close to the outer ends. The screw-fastening regions in this case are configured in the form of eyes, such that the one eye carries the screw head and the other eye carries the thread. The fastening screw lies with part of its shank exposed between the two eyes. The two lining carriers by means of hooks embrace the screw shank. In the circumferential centre of the lining carriers extensions project through a cutout in the bridge. In each of these two extensions a bore is provided. A lining-retaining pin penetrates both bores. A sheet metal spring engages under this lining-retaining pin and pulls the lining carriers towards the bridge. The sheet metal spring is supported by its ends on cutouts of the bridge.

From the European patent specification EP 359 548 i.e. a floating-caliper partially lined disc brake is known, in which the floating caliper is guided and supported via rounded ends of the lining carriers in the brake anchor plate, namely in recesses in the brake anchor plate that correspond to said rounded ends. For the friction-locked connection between lining carrier and floating caliper, the lining carrier latches with stud-like through-points into grooves of the floating caliper. A sheet metal spring riveted to the lining carrier holds lining carrier and floating caliper together.

### BRIEF SUMMARY OF THE INVENTION

A feature of the invention is to provide a floating-caliper partially lined disc brake that is of a simple design, comprises few parts, requires few machines for its manufacture and is low-noise and easy to assemble.

This feature is achieved in accordance with the features of claim 1.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is the rear view of the disc brake and the stub axle of the first embodiment;

FIG. 2 is the left side view of the disc brake and the stub axle of the first embodiment;

FIG. 3 is the right side view of the disc brake and the stub axle of the second embodiment;

FIG. 4 is the rear view of the disc brake and the stub axle of the second embodiment;

FIG. 5 is the plan view of the disc brake;

FIG. 6 is a tangential section through the disc brake;

FIG. 7 is an axial section through the disc brake;

FIG. 8 is the right side view of the disc brake, wherein the eyes of the brake anchor plate are in section;

FIG. 9 is a tangential section through the outer brake lining, through the bridge fingers and through the outer spring;

FIG. 10 is a first construction of the brake anchor plate;

FIG. 11 is the brake anchor plate in side view;

FIG. 12 is the receiving eye of the brake anchor plate and part of the brake disc;

FIG. 13 is a second construction of the brake anchor plate;

FIG. 14 is a third construction of the brake anchor plate;

FIG. 15 is the front view of the floating caliper;

FIG. 16 is an axial section through the outer brake lining and through part of the floating caliper, in particular through the pocket of the bridge finger;

FIG. 17 is the outer spring;

FIG. 18 is the plan view of the outer spring;

FIG. 19 is the front view of a second construction of the floating caliper;

FIG. 20 is a tangential section through the bridge of the second construction of the floating caliper;

FIG. 21 is a tangential section through the bridge of the second construction of the floating caliper and through part of the brake anchor plate viewed in the direction of the inner brake lining of a second construction and the support of the inner side of the bridge on the inner lining carrier;

FIG. 22 is a bottom view of the inner side of the bridge in the region of support of the inner side on the inner lining carrier;

FIG. 23 is the rear view of the disc brake;

FIG. 24 is the front view of the disc brake;

FIG. 25 is a tangential section through the bridge of the second construction of the floating caliper and through part of the brake anchor plate viewed in the direction of the inner brake lining of a first construction;

FIG. 26 is a rear view of the disc brake with a floating caliper of the second construction;

FIG. 27 is a tangential section through the bridge of the floating caliper and through part of the brake anchor plate viewed in the direction of the inner brake lining of a first construction;

FIG. 28 is the inner brake lining of a first construction;

FIG. 29 is the inner brake lining of a second construction;

FIG. 30 is the outer brake lining;

FIG. 31 is the retaining bolt of a first construction;

FIG. 32 is the retaining bolt of a second construction;

FIG. 33 is a first construction of the inner spring;

FIG. 34 is the inner spring in longitudinal section;

FIG. 35 is a second construction of the inner spring;

FIG. 36 is a third construction of the inner spring;

FIG. 37 is a fourth construction of the inner spring;

FIG. 38 is a fifth construction of the inner spring;

FIG. 39 is the inner lining carrier of the second construction;

FIG. 40 is the receiving eye of the lining carrier;

FIG. 41 is the inner lining carrier of the first construction with the damping plate;

FIG. 42 is the region of the receiving eye of the damping plate;

FIG. 43 is a side view of the region of the receiving eye of the damping plate;

FIG. 44 is the receiving eye of the lining carrier with the webs of the damping plate;

FIG. 45 is the slight oversize of the web of the damping plate in the bay of the receiving eye;

FIG. 46 is a further construction of the receiving eye of the lining carrier with the webs of the damping plate;

FIG. 47 is the slight oversize of the web of the damping plate in the bay of the receiving eye of the further construction;

FIG. 48 is the inner brake lining in side view;

FIG. 49 is the radial projection of a first construction;

FIG. 50 is the radial projection of a second construction;

FIG. 51 is the radial projection of a third construction;

FIG. 52 is the radial projection of a fourth construction;

FIG. 53 is a representation of the resultant of the spring force of the inner spring, the reaction force and the force of gravity.

### DETAILED DESCRIPTION OF THE INVENTION

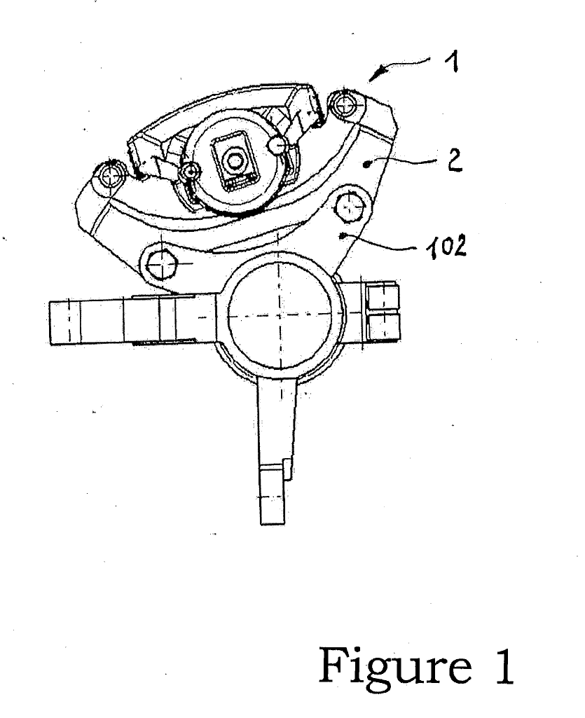

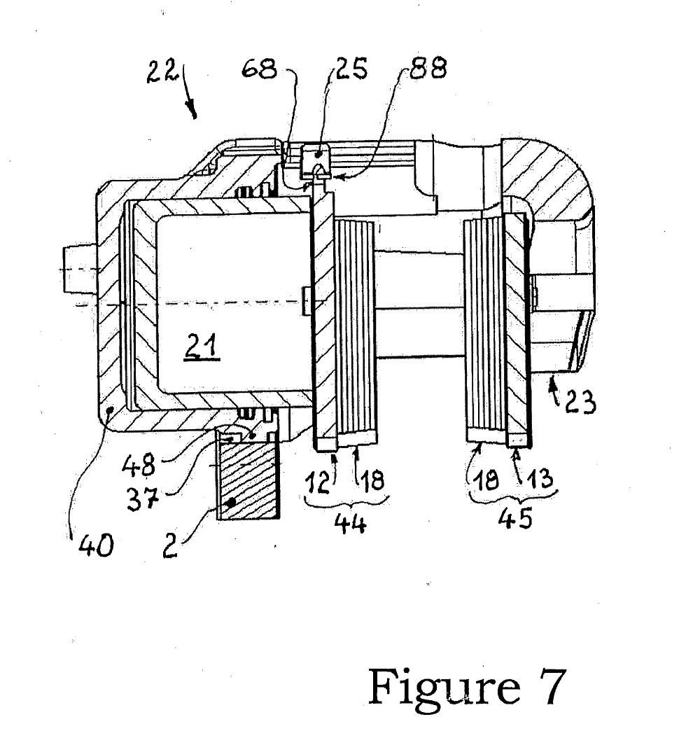

In FIG. 1 the basic arrangement of the disc brake (1) on the stub axle (102) is represented. Here, the disc brake (1) is fastened by its brake anchor plate (2) by means of two screws to arms of the stub axle (102). This view of the disc brake (1) is referred to, in the description that follows, as the rear view of the disc brake (1), this being the view of the cylinder (40) according to FIG. 7.

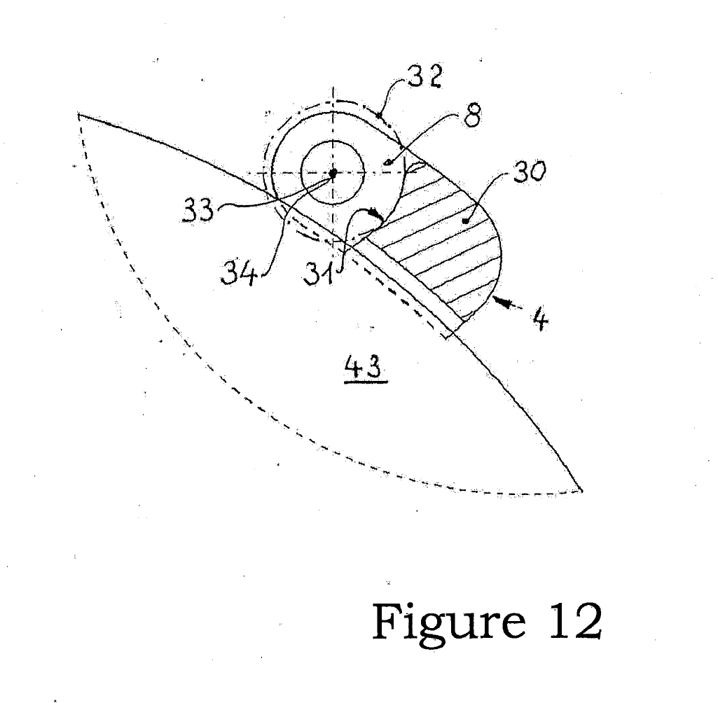

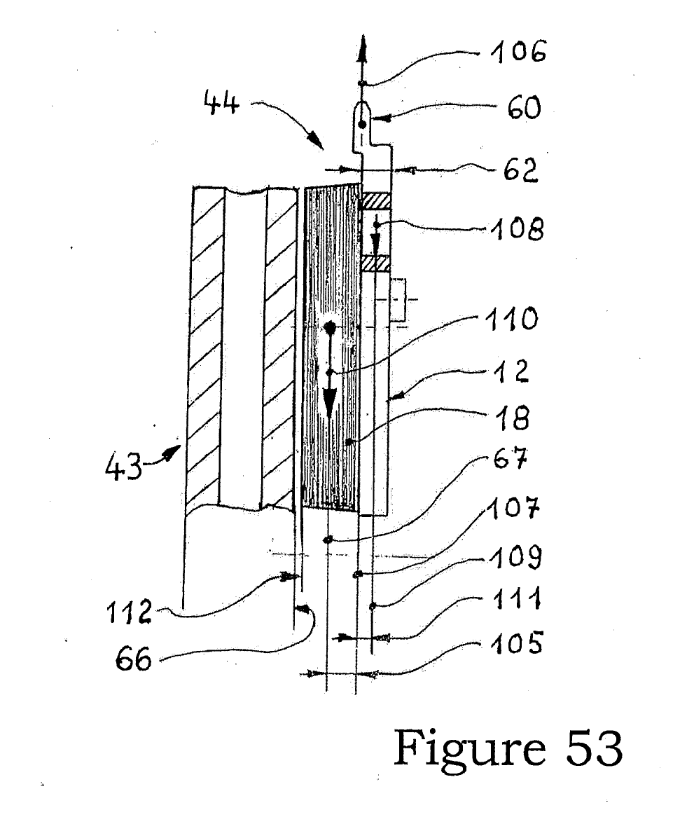

The axis system indicated in FIG. 1 is also the axis system for the brake disc (43) shown in FIGS. 12 and 53. Through the point of intersection of this axis system the axis of rotation of the brake disc (40) extends at right angles thereto.

The construction of the connection of the disc brake (1) by the brake anchor plate (2) to the stub axle (102) that is shown in FIG. 1 represents the basic construction and is to be referred to as the first embodiment.

Given an assumed principal direction of rotation of the brake disc in clockwise direction, the left side of the disc brake (1) in FIG. 1 is to be referred to as the run-in side and the right side as the run-out side.

Axial, in the description that follows, is to be regarded as a direction that extends along the axis or parallel to the axis of the brake disc (43).

Radial, in the description that follows, is to be regarded as a direction that extends at right angles to the axis of the brake disc (43).

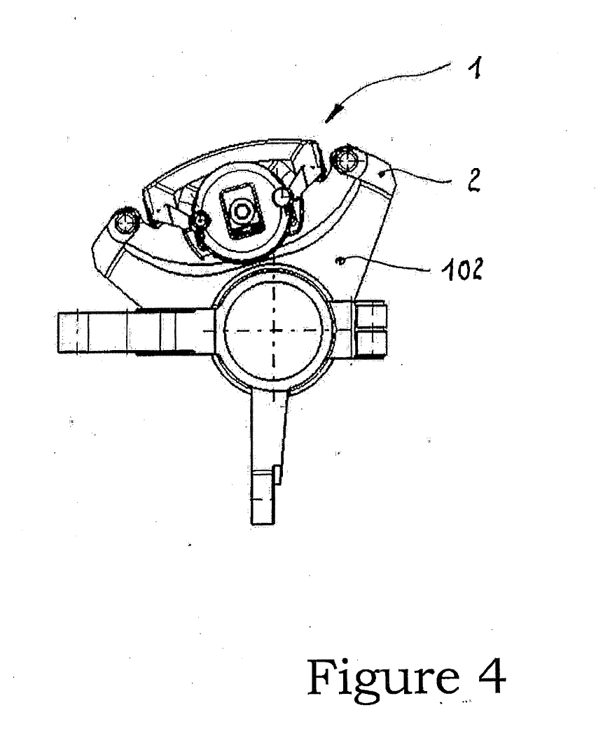

In FIG. 4 a further construction of the connection of the disc brake (1) to the stub axle (102) is represented. The brake anchor plate (2) is integrated into the stub axle (102). It is an integral component of the stub axle (102). This construction of the connection is to be designated as the second embodiment.

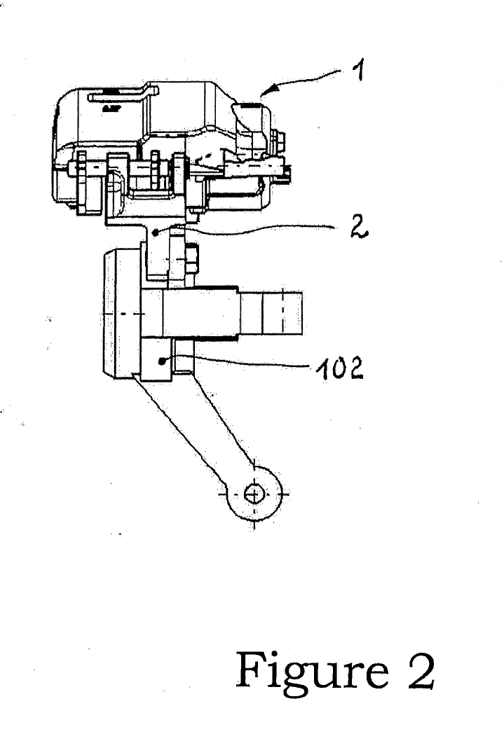

FIG. 2 shows the left side view of the disc brake (1), the brake anchor plate (2) and the stub axle (102) of the first embodiment of the connection, with reference to the rear view according to FIG. 1.

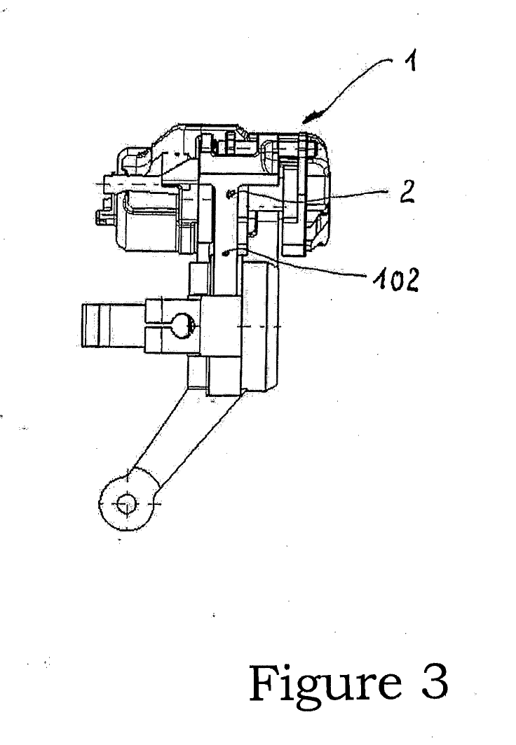

FIG. 3 shows the right side view of the disc brake (1), the brake anchor plate (2) integrated into the stub axle (102), and the stub axle (102) of the second embodiment of the connection, with reference to FIG. 4.

While the further description relates to the first embodiment, it is also to apply analogously to the second embodiment.

The disc brake (1) as such comprises the main parts: floating caliper (22), piston (21), brake anchor plate (2) and brake linings (44), (45).

The brake anchor plate (2) forms the foundation of the brake; it carries the floating caliper (22) and introduces the brake forces of the brake linings (44), (45) into the stub axle (102).

The floating caliper (22) contains a cylinder (40), the bridge (26) and the bridge fingers (23).

The cylinder (40) comprises a piston (21), which upon actuation of the disc brake (1) is loaded with pressure by a hydraulic liquid and as a result of the force arising from this hydraulic pressure moves out of the cylinder (40). In so doing, it pushes the inner brake lining (44) towards the brake disc (43).

The same hydraulic pressure that acts upon the piston (21) also acts upon the base of the cylinder (40). There too, it generates a force. This force moves the cylinder (40) counter to the direction of motion to the piston (21).

The cylinder (40) transmits this movement to the bridge (26). The bridge (26) in turn transmits this movement to the bridge fingers (23). The bridge fingers (23) push the outer brake lining (45) towards the brake disc (43).

To the extent that the brake linings (44), (45) wear, their position in relation to the brake anchor plate (2) also varies.

Given conventional, uniform wear of the inner and the outer brake lining (44), (45), the variation of their position in relation to the brake anchor plate (2) occurs uniformly.

In relation to the floating caliper (22) the variation of the position of the brake linings (44), (45) does not occur uniformly: the outer brake lining (45) does not vary its position in relation to the bridge fingers (23). It moves simultaneously with the floating caliper (22).

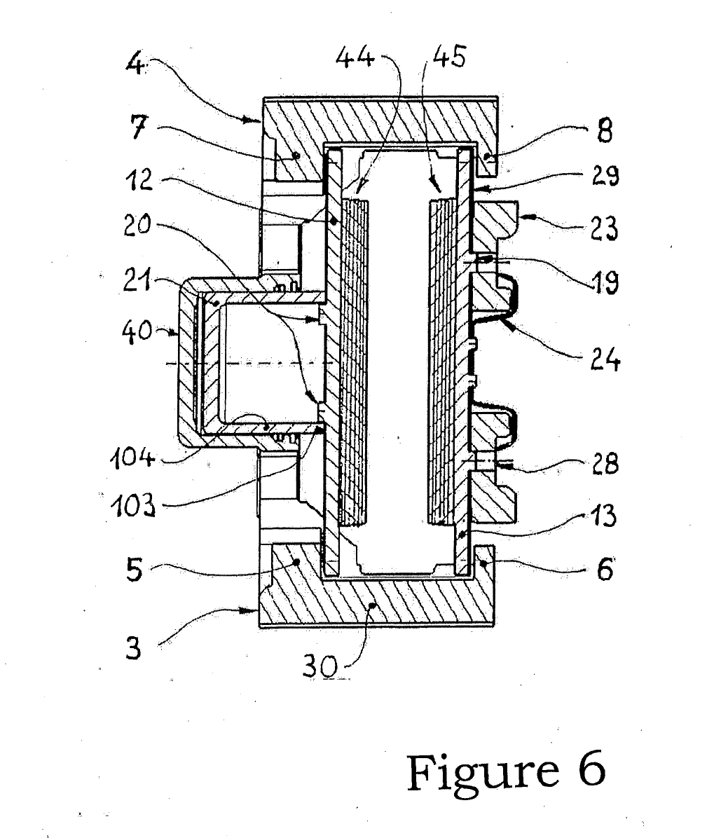

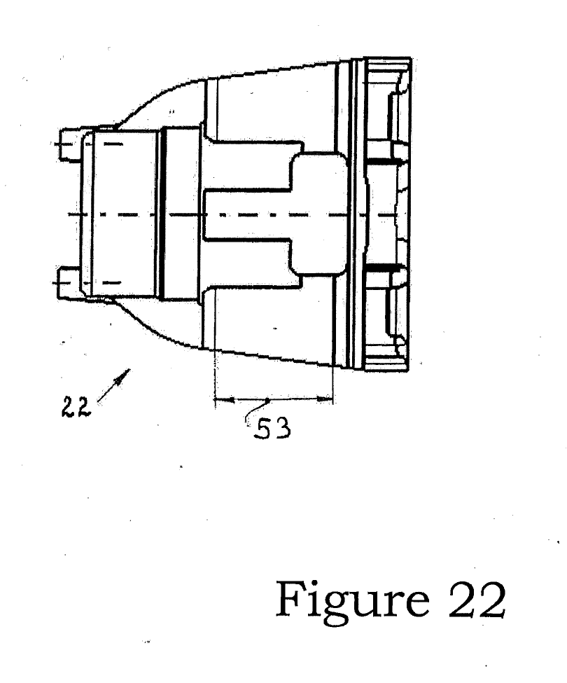

The inner brake lining (41), on the other hand, varies its position in relation to the floating caliper (22) to a considerable extent: as the outer brake lining (45) wears, the floating caliper (22) moves by this wear distance, in FIG. 6, to the left. At the same time, however, the inner brake lining (44) also moves by its wear distance, in FIG. 6, to the right. Thus, the inner brake lining (44) varies its position in relation to the floating caliper (22) by twice as much as it does in relation to the brake anchor plate (2). Knowing and taking this into account is important for correct selection of the dimension (46) of the axial extent of the surface (41) and the dimension (53), FIG. 22, of the axial extent of the lateral surface (50), FIG. 20, this being discussed in more detail at a later point of the description.

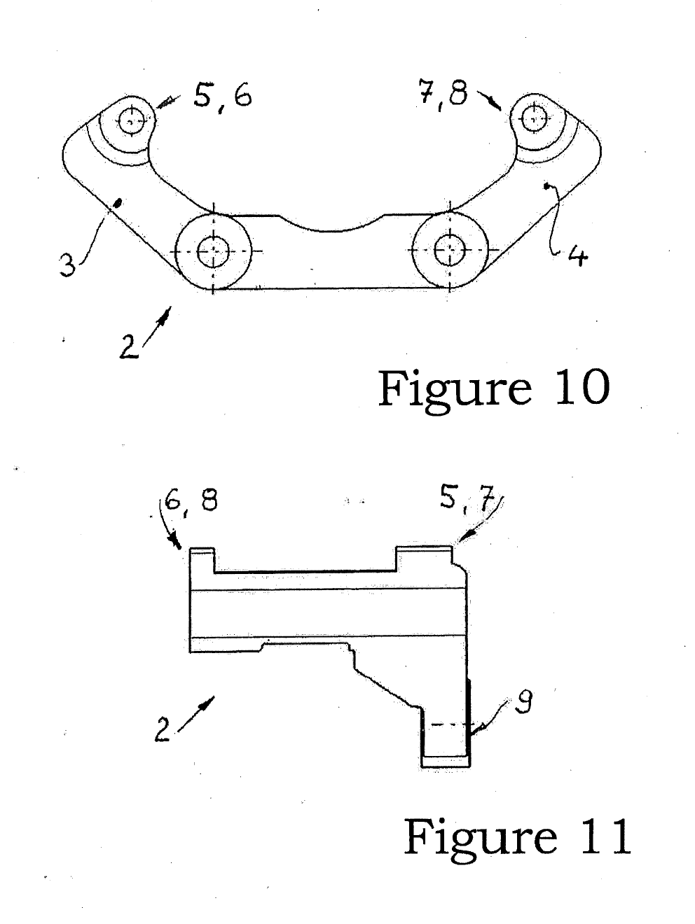

The brake anchor plate (2), FIGS. 10, 11, 12, 13 and 14, has two screw-on eyes (38), which are connected to one another by means of a connecting web (35). By means of screws these screw-on eyes (38) are detachably connected to the stub axle (102), FIG. 1.

This does not apply if the brake anchor plate (2) according to the second construction is an integral component of the stub axle (102), FIG. 4.

Two brake anchor plate arms (3) and (4) extend from the screw-on eyes (38), wherein the—in FIG. 10—left brake anchor plate arm (3) is hereinafter referred to as the brake anchor plate arm (3) on the run-in side or the run-in-side brake anchor plate arm (3), and the—in FIG. 10—right brake anchor plate arm (4) is hereinafter referred to as the brake anchor plate arm (4) on the run-out side or the run-out-side brake anchor plate arm (4).

The side of the brake anchor plate (2) that has the screw-on plane (9), on the right in FIG. 11, is referred to as the inner side of the brake anchor plate (2), the opposite side as the outer side.

Both brake anchor plate arms (3), (4) span the brake disc (43).

The inner side of the brake anchor plate (2) has on the run-in-side brake anchor plate arm (3) the inner, run-in-side receiving eye (5) and on the run-out-side brake anchor plate arm (4) the inner, run-out-side receiving eye (7).

The outer side of the brake anchor plate (2) has on the run-in-side brake anchor plate arm (3) the outer, run-in-side receiving eye (6) and on the run-out-side brake anchor plate arm (4) the outer, run-out-side receiving eye (8).

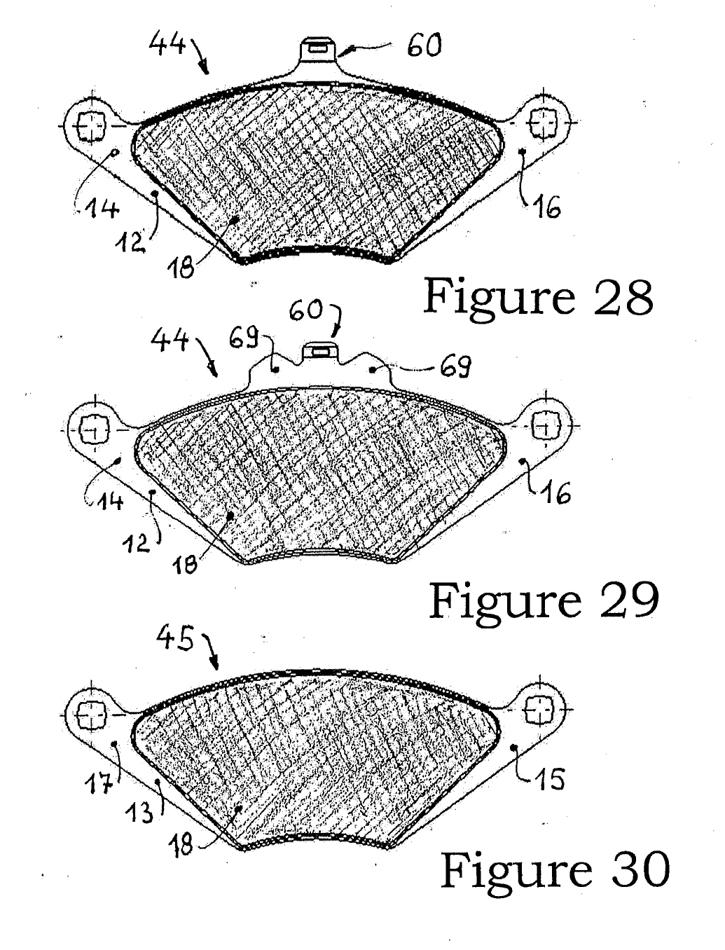

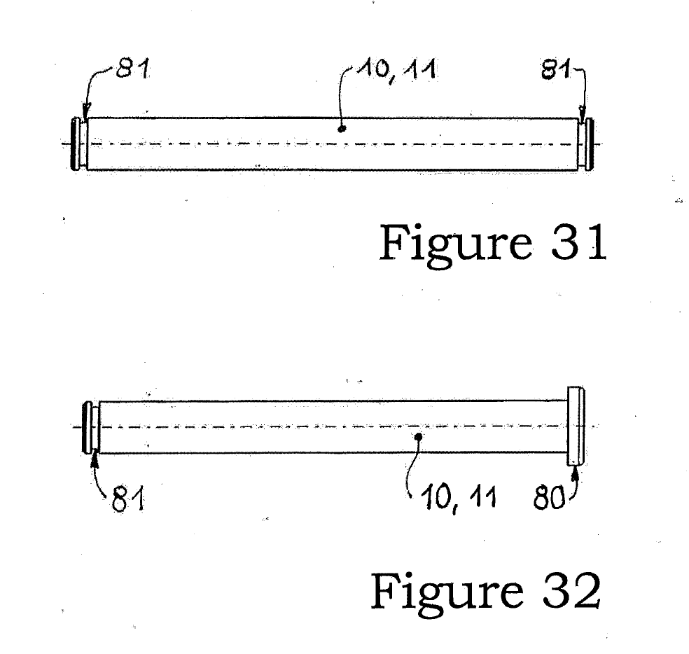

The receiving eyes (5), (6), (7) and (8) have bores for supporting retaining bolts (10), (11), FIGS. 31, 32, which penetrate the receiving eyes (14), (15), (16) and (17) of the lining carriers (12), (13), FIGS. 28, 29 and 30.

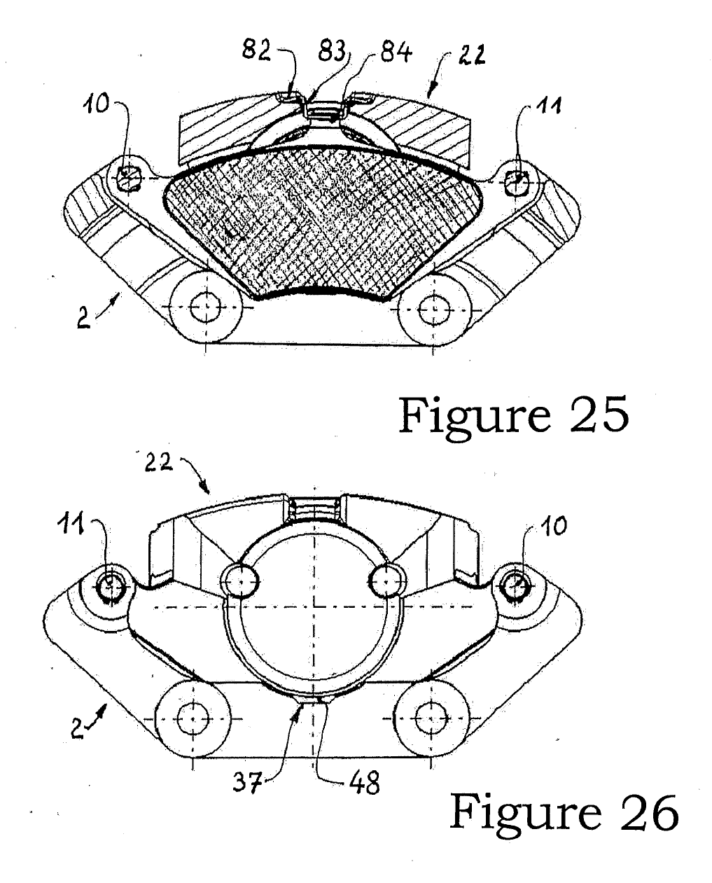

The cross section (30) of the region of the run-out-side brake anchor plate arm (4) that spans the brake disc (43) is represented in FIG. 12. The reference numeral (34) denotes the axis of the run-out-side receiving eyes (7), (8). Situated on, or at least close by this axis (34) is a further axis, the cylinder axis (33). The cylinder lateral surface (32) belonging to the cylinder axis (33) produces in the cross section (30) of the brake anchor plate arm (4) a hollow (31). This hollow (31) is so dimensioned that the receiving eyes (16), (17) of the lining carriers (12), (13), FIGS. 28, 29, 30 and FIG. 25, which are guided and supported on the retaining bolt 11, have a slight clearance relative thereto. The same applies to the hollow (31) of the run-in-side brake anchor plate arm (3), the retaining bolt (10) and the receiving eyes (14), (17).

The brake anchor plate (2) requires only a little stock removal: introduction of the bores for receiving the retaining bolts (10), (11) and the bores for receiving the fastening screws is sufficient. The bores for receiving the fastening screws moreover have to be mirror-image machined or evened out with a cutter at both sides.

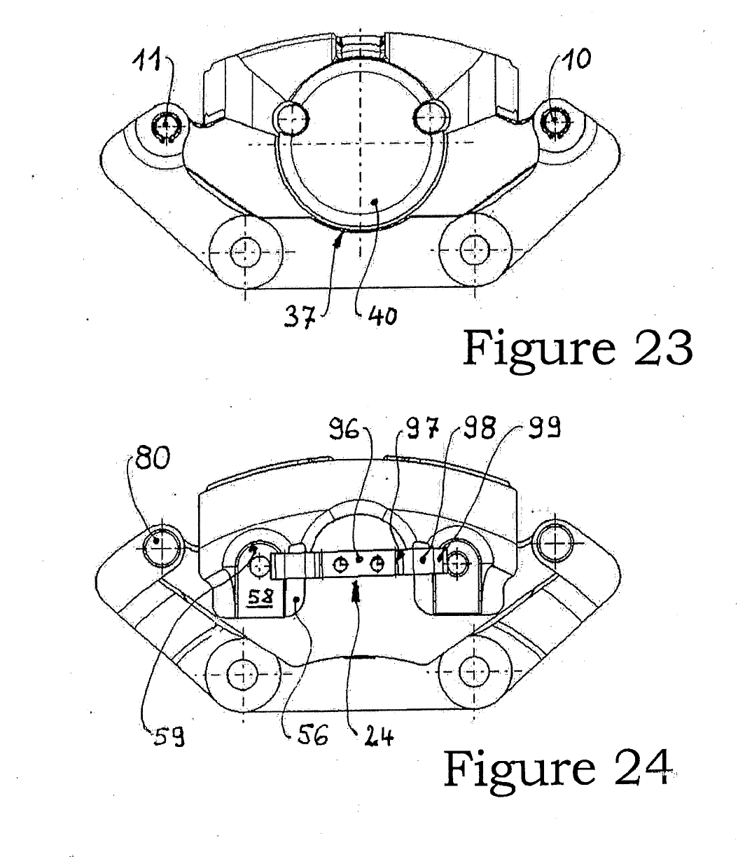

The brake anchor plate (2) may have in its connecting web (35) a groove-shaped recess (37), which may be provided for example if a cylinder (40), FIG. 23), of a larger diameter is to be used. This recess (37) may then be already provided in the unmachined part, in which case no further stock removal is required.

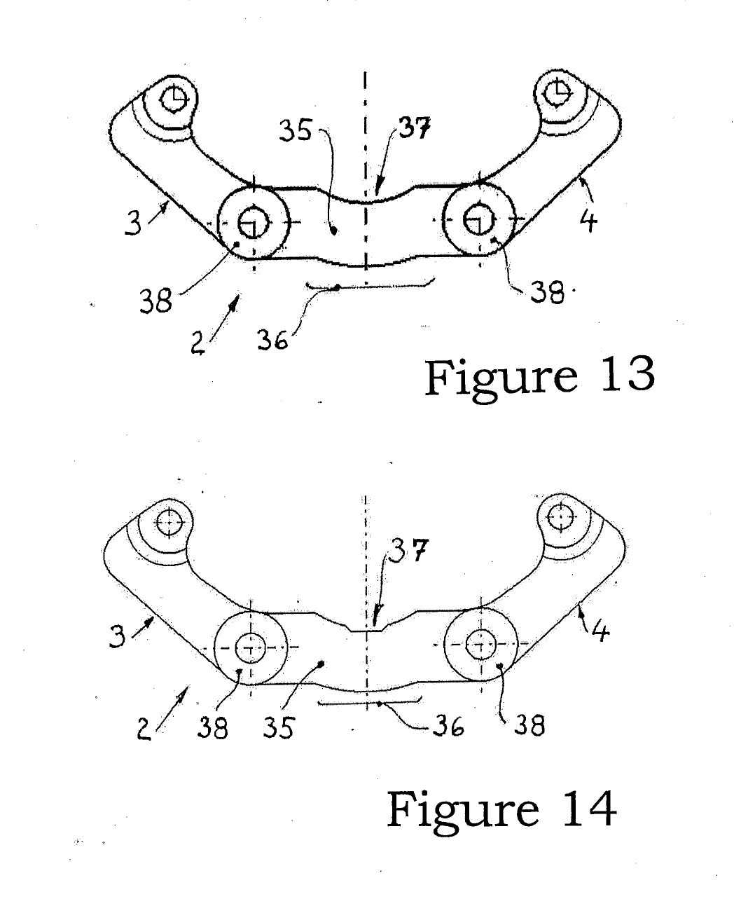

According to a second construction of the brake anchor plate (2), FIG. 13, the brake anchor plate (2) at the opposite side of the connecting web (35) to the groove-shaped recess (37) may have a bulge, as is represented in FIGS. 13 and 14.

In this way, the reduction in strength of the connecting web caused by the groove-shaped recess (37) may be compensated.

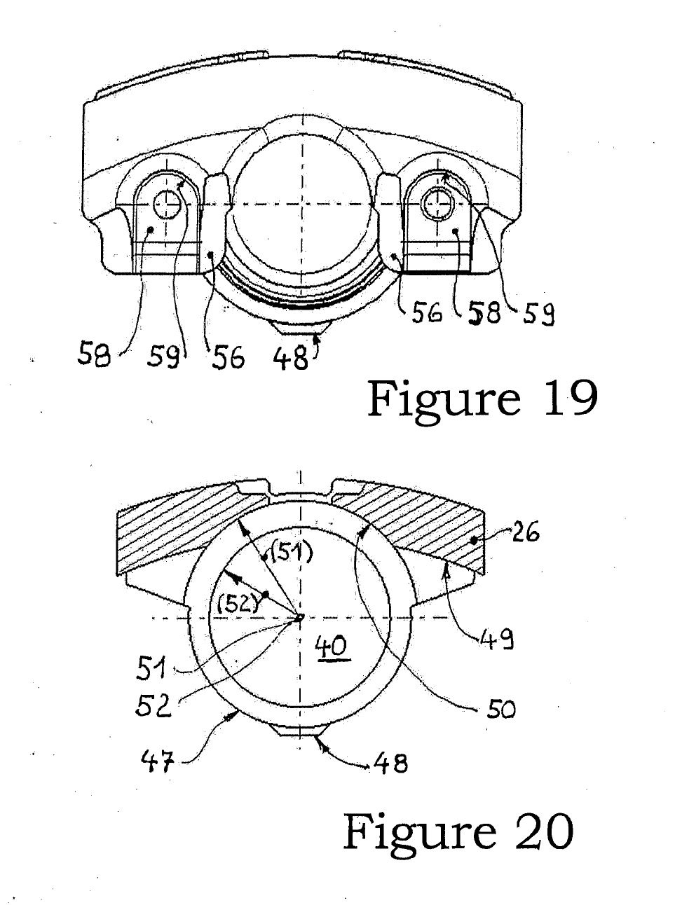

According to a third construction of the brake anchor plate (2), FIG. 14, the groove-shaped recess (37) may have a planar surface that forms a supporting surface for a projection (48) of the cylinder (40), FIGS. 7, 19, 20.

The brake linings (44), (45) are represented in FIGS. 28, 29 and 30, wherein FIG. 28 shows the inner brake lining (44) of a first construction, FIG. 29 the inner brake lining (44) of a second construction and FIG. 30 the outer brake lining (45).

In principle, the brake linings (44), (45) comprise the lining carrier (12), (13), the friction mass (18) and mostly additionally a damping plate (29).

Common to all three constructions of the lining carriers (12), (13) are the receiving eyes (14), (15), (16) and (17), the friction mass (18) and the damping plate (29).

The lining carrier (12) of the first construction of the inner brake lining (44) has in its tangential centre a radial projection (60). This is used to connect the inner spring (25).

The lining carrier (12) of the second construction of the inner brake lining (44) in its tangential centre likewise has a radial projection (60). It too is used to connect the inner spring (25). The lining carrier (12) further has, symmetrically to the projection (60), two further radial projections (69). They are used to support the floating caliper (22).

FIG. 31 shows the retaining bolt (10), (11) of a first construction and FIG. 32 shows the retaining bolt (10), (11) of a second construction.

The retaining bolts (10), (11) are supported in the receiving eyes (5), (6), (7) and (8) of the brake anchor plate (2). They are prevented from drifting axially out of the bores of the receiving eyes (5), (6), (7) and (8) in the first construction by means of circlips, which are held in the grooves (81), and in the second construction by means of the head (80) and a circlip, which is held in the groove (81).

The retaining bolts (10), (11) transmit the brake forces to the brake anchor plate (2). They moreover transmit the mass acceleration forces of the brake linings (44), (45) and at least partially of the floating caliper to the brake anchor plate (2).

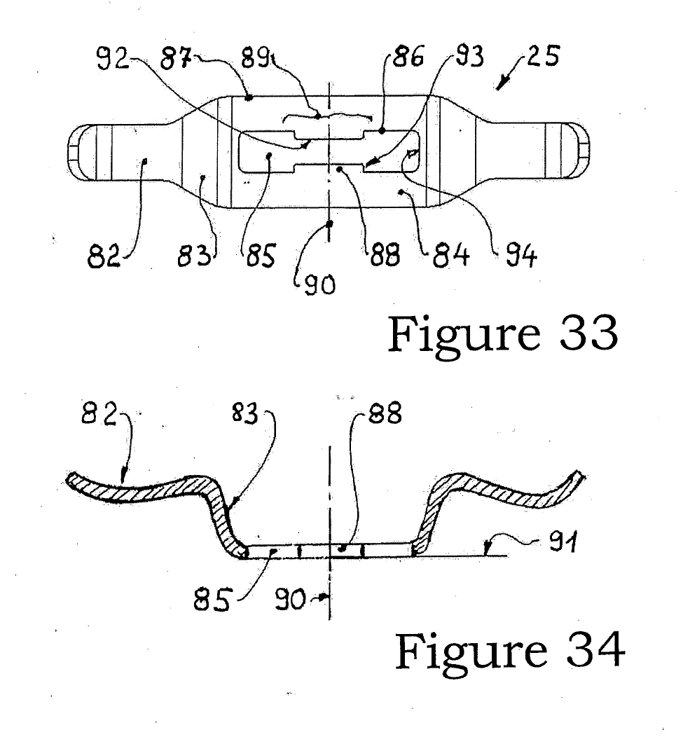

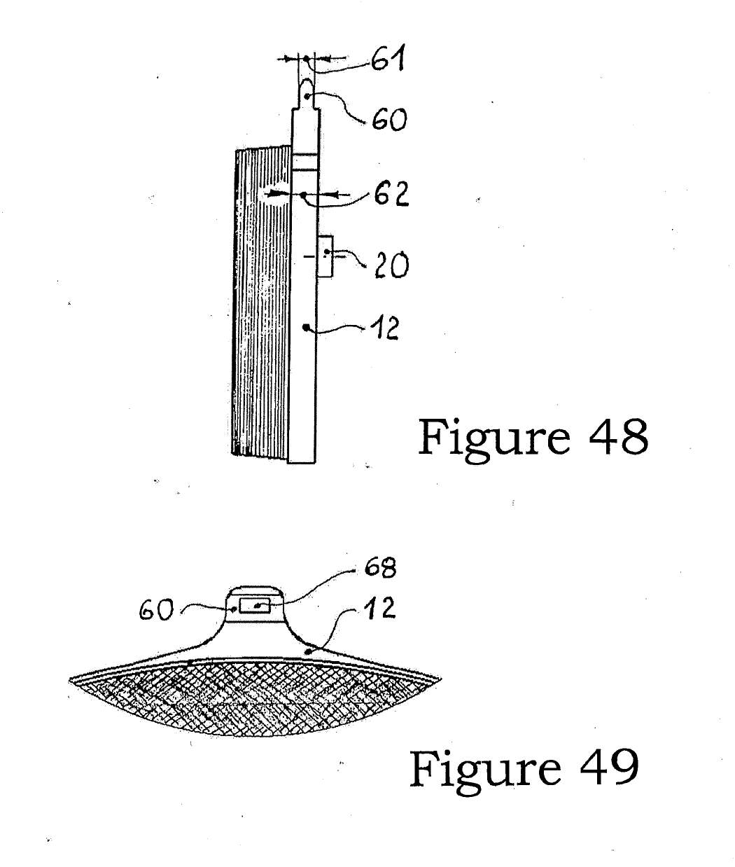

FIG. 48 shows the inner brake lining (44) in side view, FIGS. 49, 50, 51 and 52 show various constructions of the radial projection (60), and FIGS. 33 to 38 show various constructions of the inner spring (25).

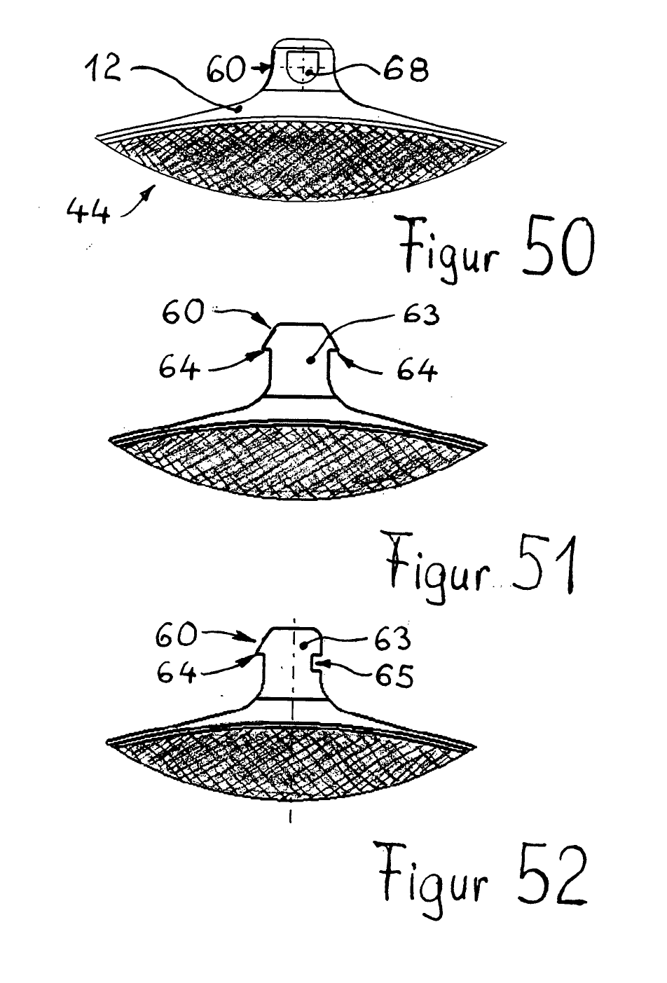

The first construction of the radial projection (60), FIGS. 48 and 49, has an axial thickness (61) that is less than the thickness (62) of the lining carrier (12). In this construction the radial projection (60) is disposed centrally relative to the lining carrier plate (12). The radially outer region of the projection (61) is provided on all sides with a slight chamfer. An undercut (68) in the projection (60) is used to connect the inner spring (25) to the lining carrier (12). The undercut (68) in the construction shown in FIG. 49 is rectangular in shape. It may nevertheless also be of a different shape, as is represented in the second form of construction in FIG. 50. Here, the radially outer edge of the undercut (68), as in the first construction according to FIG. 49, extends in tangential direction. As the cross section of the die for producing the undercut (68) is to be selected as large as possible, the radially inner, rounded region of the undercut (68) of the second construction according to FIG. 50 offers more surface area for the cross section of the die.

FIG. 51 shows a third embodiment of the projection (60). The broad side (63) has two barbs (64).

In the fourth embodiment of the radial projection (60) according to FIG. 52 the radial projection (60) has a barb (64) and a groove (65) in the broad side.

The inner spring (25), which is represented in five constructions in FIGS. 33 to 38, has a planar bottom surface (84) that is rectangular in shape. Adjoining the bottom surface (84) are side walls (83), which in the non-tensioned state of the spring (25) include an angle in the order of magnitude of 70° with the plane (91) of the bottom surface (84). Adjoining these side walls (83) are the spring legs (82). The spring legs (82) are likewise approximately rectangular in shape, being however narrower than the bottom surface (84). The side walls (83) converge from the broader bottom surface (84) towards the narrower spring legs (82). The spring legs (82) as such extend with a slight inclination relative to the plane (91). Near their ends the spring legs (82) verge in a transition radius into their end regions, which extend away at an angle in the order of magnitude of 45° relative to the plane (91).

The bottom surface (84) has a cutout (85). This is rectangular in shape. The longitudinal sides of the rectangular cutout (85) run parallel to the longitudinal sides (87) of the bottom surface (84). In the central region (89) of the longitudinal sides (86) of the cutout (85) projections (88) project towards the centre of the cutout (85). The spacing between the end faces (92) is less than the thickness (61) of the radial projection (60) of the inner lining carrier (12), FIG. 48.

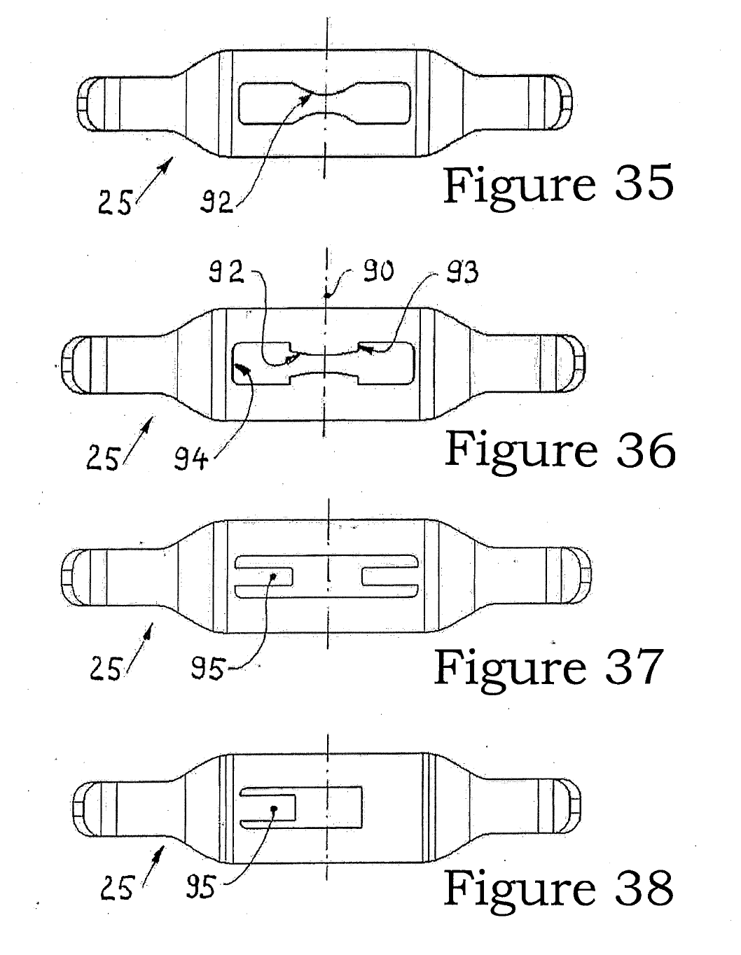

The second construction of the inner spring (25) is represented in FIG. 35. The projections (88) are of a convex construction, the spacing between the end faces (92) in the central region here being smaller than the thickness (61) of the radial projection (60) of the inner lining carrier (12).

The third construction of the inner spring (25) is represented in FIG. 36. The projections (88) are likewise of a convex construction, and the spacing between the end faces (92) in the central region here is also smaller than the thickness (61) of the radial projection (60) of the inner lining carrier (12). The radius of curvature of the convex projections (88) is greater here than in the second construction according to FIG. 35. Furthermore, the end faces (92) of the convex projections terminate in side edges (93), which run parallel to one another and at right angles to the longitudinal sides (86) of the cutout (85).

The described three constructions are provided for the radial projections (60) according to FIGS. 49 and 50. The inner spring (25) is pressed onto the radial projection (60). The all-side, radially outer chamfering of the projection (60) enables easy introduction of the projection (60) into the cutout (85) of the bottom surface (84) of the inner spring (25). As the spring (25) is pressed in, the projections (88) deform until they slide over the broad side (63) of the projection (60) and latch into the undercut (68).

The spacing of the parallel side edges (93) may be tuned in such a way to the width of the undercut (68) that the spring is centred in tangential direction by the undercut (68). The spring (25) in the second construction according to FIG. 35 may likewise be centred by adapting the curvature of the convex projection (88) to the tangential width of the undercut (68).

The fourth construction of the inner spring (25) is represented in FIG. 37. The spring (25) has in the bottom surface (84) of the cutout (85) two tongue-shaped projections (95), which extend from the broad sides (94) of the cutout (85) towards the centre (90). This spring (25) interacts with the third construction of the radial projection (60), FIG. 51. During assembly the tongue-shaped projections (95) slide along the slopes of the barbs (64), wherein the projections (95) bend slightly until they latch in under the barbs (64).

The fifth construction of the inner spring (25) is represented in FIG. 38. The spring (25) has in the bottom surface (84) of the cutout (85) only a single tongue-shaped projection (95), which extends from one of the broad sides (94) of the cutout (85) towards the centre (90). This spring (25) interacts with the fourth construction of the radial projection (60), FIG. 52. To mount this spring (25), the broad side (94) lying opposite the tongue-shaped projection (95) is inserted into the groove (65) of the radial projection (60). The broad side (94) together with this groove (65) forms a bearing point. A force is then exerted on the side of the spring (25) containing the projection (95), wherein the tongue-shaped projection (95) slides along the slope of the barb (64) until it finally latches in under the barb (64). As the introduction point of the force lies at a distance from the bearing point of the broad side (94) in the groove (65), this introduction point forms with the bearing point a lever arm that is approximately two to three times as great as the lever arm formed by the distance between the introduction point of the reaction force,—i.e. the point on the slope of the barb (64), on which the end of the tongue-shaped projection (95) facing the centre (90) rests,—and the bearing point of the broad side (94) in the groove (65).

This allows the spring (25) to be mounted with a markedly lower force, this being important for a machine-free assembly.

Brake linings (44), (45) are generally provided with damping plates (29). Damping plates (29) are used in particular to reduce audible vibrations that are generated by the rubbing of the friction mass (18) against the brake disc (43). For this reason, insofar as is possible the transmission path of the vibrations is damped with resistance devices. Such resistance devices for preventing propagation of the vibrations are formed for example by rubber-coated metal plates, which are generally referred to as damping plates (29). The damping plates (29) are attached, mostly glued, to the side of the lining carriers (12), (13) remote from the friction mass (18).

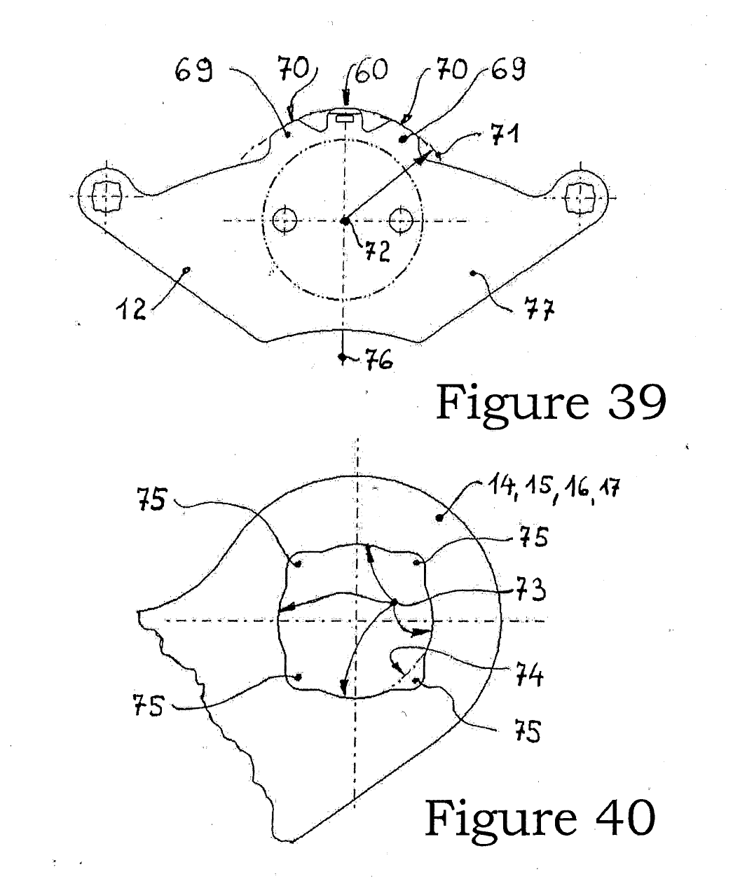

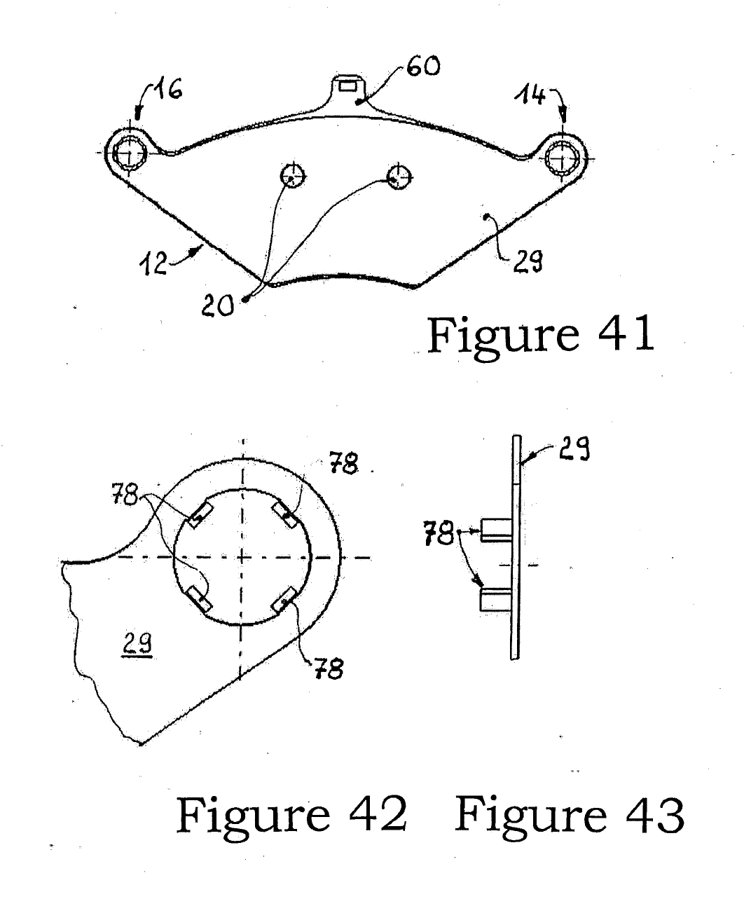

In FIGS. 39 to 47 the particulars of the lining carriers (12), (13) and the damping plate (25) are described in detail. While the inner lining carrier (12) is represented in FIGS. 39 and 41, the following description also applies analogously to the outer lining carrier (13). The lining carriers (12), (13) have receiving eyes (14), (15), (16) and (17), by means of which they are supported and guided by the retaining bolts (10), (11) in the brake anchor plate (2).

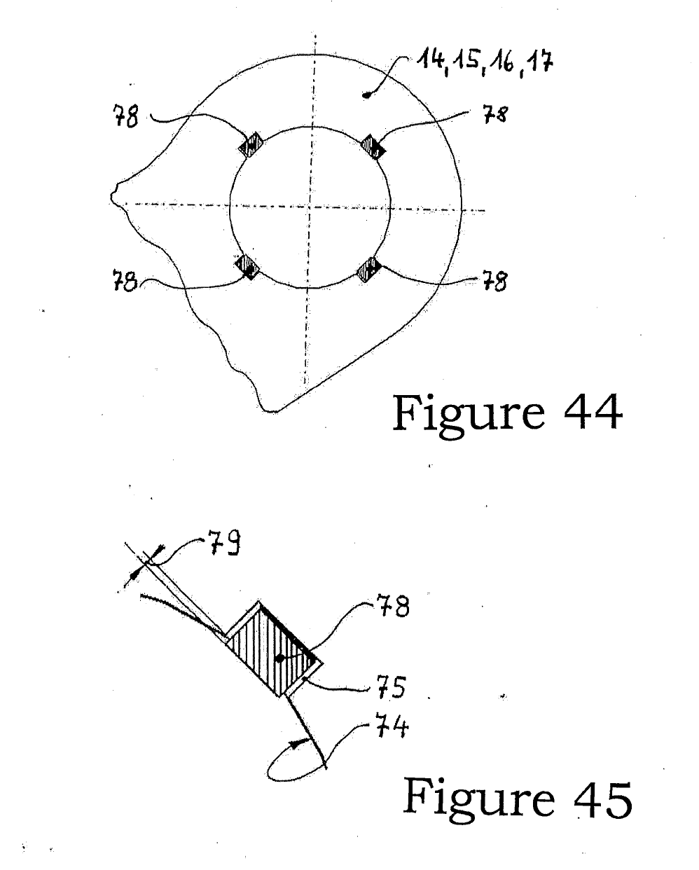

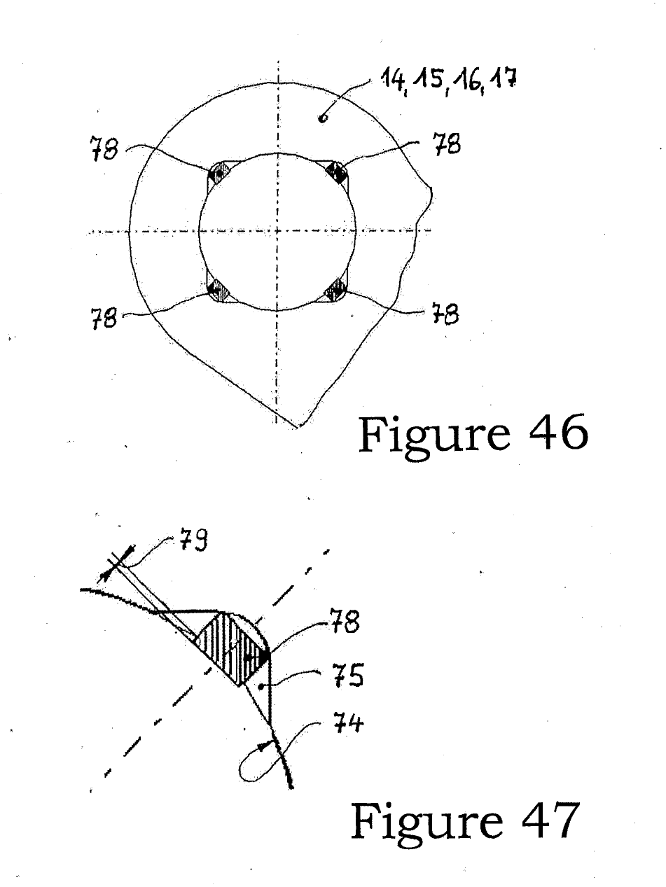

Each one of these receiving eyes (14), (15), (16) and (17) has an undercut, the basic shape of which is a circle having the outside circumference (74). Worked into this outside circumference (74) are four bays (75). The bays (78) may have the shape of a rectangle, FIGS. 44 and 45, but may also have a different shape, for example a curve adjoined by parts of a straight line, as represented in FIGS. 46 and 47.

The damping plate (29) has a basic shape, the area of which is substantially congruent with the area of the lining carrier (12), (13), this basic shape in particular also overlapping the receiving eyes (14), (15), (16) and (17).

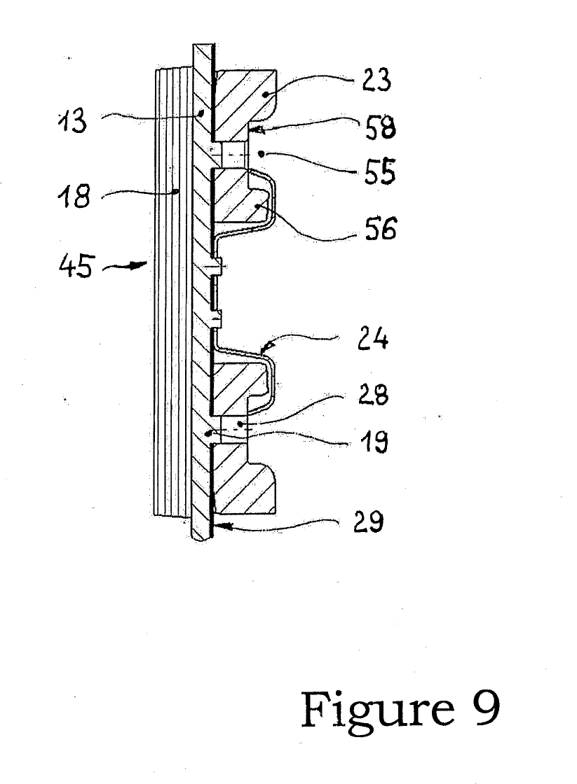

In a departure from this congruence there are situated in the damping plate undercuts, which comprise through-points (19), (20) of the lining carrier (12), (13), FIG. 6, as well as through-points for fastening the outer spring (24), FIG. 9. The radial projections (68), (69) may moreover remain free of damping plate (29).

Formed out from the inner surface of the receiving eyes of the damping plate (29) are webs (78). These webs (78) are bent out from the plane of the damping plate (29) and extend approximately at right angles to this plane.

The damping plate (29) is glued onto the rear of the lining carrier (12), (13). The webs (78) fill the bays (75) of the receiving eyes (14), (15), (16) and (17).

The bays (75) in the receiving eyes (14), (15), (16) and (17) of the lining carriers (12), (13) are so dimensioned that the webs (78) of the damping plate (29) fill these bays (75) with a slight oversize (79), FIGS. 45 and 46. The webs (78) project by the oversize (79) beyond the outside circumference (74).

When the brake linings (44), (45) are fastened to the brake anchor plate (2) by means of the retaining bolts (10), (11), the retaining bolts (10), (11) slightly compress the webs (78) of the damping plate (29). The webs (78) remain throughout displacement of the brake linings—i.e. also during the braking operation—permanently in contact with the surface of the retaining bolts (10), (11). Consequently, the vibration of the retaining bolts (10), (11) and the transmission of the vibrations initiated by the rubbing of the friction mass (18) against the brake disc (43) is damped. The oversize (79) and hence the extent of compression of the webs (78) and the associated initial tension of the rubber coating of the damping plate (29) are determined empirically.

In order to maintain this initial tension of the rubber coating of the webs (78) of the damping plate (29) over a long period and prevent it from being altered by lining forces, in particular by forces occasioned by the braking operation, it is provided that the bays (75) are distributed over the circumference of the basic shape of the circle (73) in such a way that lining forces, which act parallel to the axis of symmetry (76) of the lining carrier (12), (13) and parallel to the plane (77) of the lining carrier (12), (13), and lining forces, which act at right angles to the axis of symmetry (76) of the lining carrier (12), (13) and parallel to the plane (77) of the lining carrier (12), (13), are transmitted always into regions of the outside circumference (74) of the circle of the basic shape (73).

In simple terms: radial and tangential lining forces are transmitted, not into the bays (75), but always into the remaining outside circumference (74) of the circle (73).

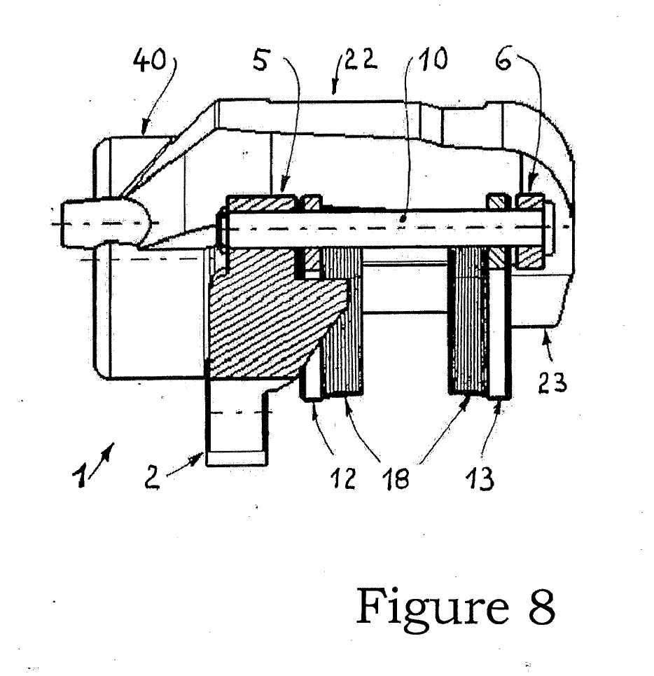

The outer brake lining (45), FIGS. 30, 6, 7, 8, 9, 15, 16, 19 and 24, in particular FIGS. 9 and 16, has on the rear of the lining carrier (13) two larger through-points (19). These through-points (19) engage into recesses (28) of the bridge fingers (23) of the floating caliper (22). They form a positive connection of lining carrier (13) and bridge finger (23). The lining carrier (13) moreover has two further smaller through-points, which are used to fasten the outer spring (24).

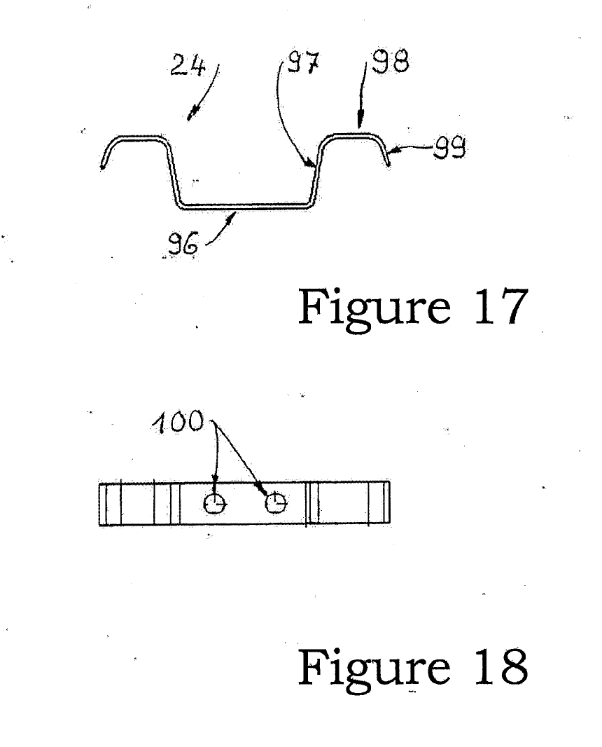

The outer spring (24), FIGS. 17 and 18, comprises a planar base plate (96), which is adjoined by side walls (97). The side walls (97) in the non-tensioned state of the spring (24) diverge slightly from one another. With the base plate they each include an angle of approximately 80°.

The side walls (97) are adjoined by the spring arms (98). The spring arms (98) terminate in angled end pieces (99). In the central part of the base plate (96) the spring (24) has two holes (100), which are used to fasten the spring to the lining carrier (13). The spring (24) may be manufactured as a simple sheet metal part.

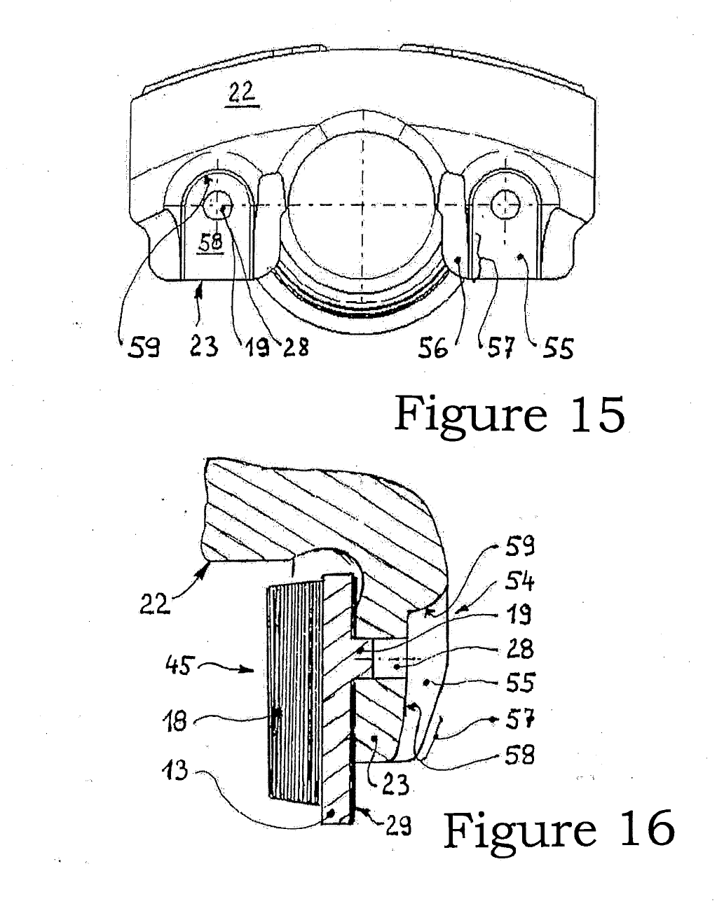

The bridge fingers (23), in particular FIGS. 15 and 16, of the floating caliper (22) have at their side remote from the brake lining (45), i.e. the outer region (54), pockets (55).

The pockets (55) are surrounded by a boundary, of which the inner boundary (56) interacts with the inner spring (24) during assembly of the brake lining (45) with the bridge fingers. The inner boundary (56) has an inlet (57). The inlet (56) extends in a slightly inclined manner. For assembly, the bridge fingers (23) are pushed with the inlet (57) under the spring arms (98) of the inner spring (24).

The spring arms (98) in this case slide along the slope of the inlet (57). In so doing they are progressively deformed.

The bridge fingers (23) are pushed under the spring arms (98) until the through-points (19) of the outer brake lining (13) are latched into the bores (28) of the bridge fingers (23). The spring (24) may also be configured in such a way that the ends of the angled end pieces (9) slide along the pocket plane (58) and are supported thereon.

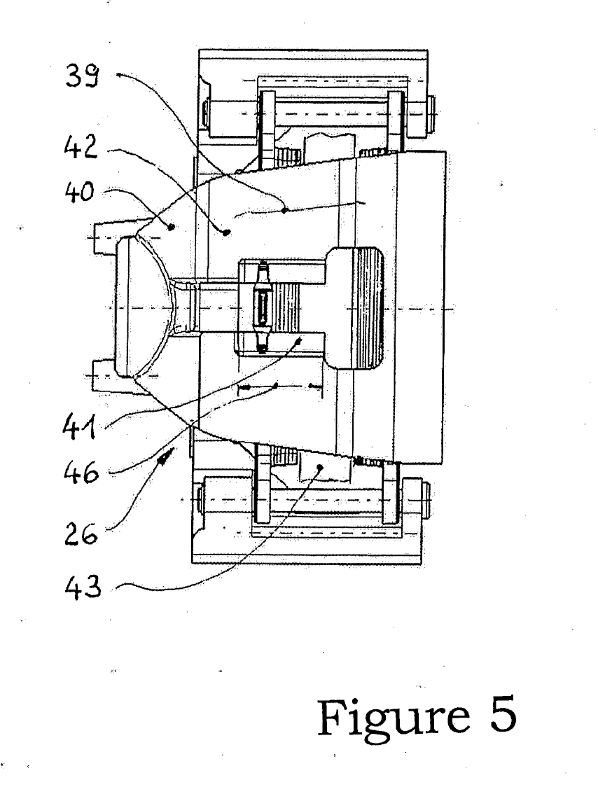

The inner brake lining (44), FIGS. 28, 30, 5, 6, 7, 21, 27, 39, has on its side of the lining carrier (12) remote from the friction mass (18) larger through-points (20), which form a positive connection with the piston skirt (104), FIG. 6. Depending on the arrangement of these through-points (20), radial and/or tangential forces of the floating caliper (22) may be transmitted via the piston skirt (104) of the piston (21) to the lining carrier (12) and supported. The lining carrier (12) transmits these forces via the retaining bolts (10), (11) into the brake anchor plate (2).

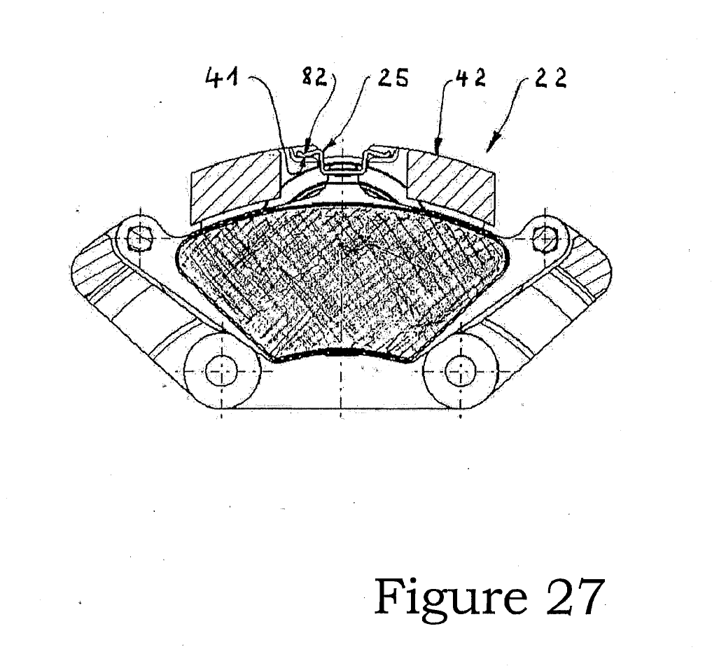

Both the lining carrier (12) of a first construction of the brake lining (45) according to FIG. 28 and the lining carrier (12) of a second construction of the brake lining (45) according to FIG. 29 have in each case a radial projection (60) that interacts with one of the inner springs (25) according to FIGS. 33 to 38. In the assembled state of the brake lining (45) with the floating caliper (22), the spring arms (82) exert a force on the surfaces (41), FIG. 5 and FIG. 27, in such a way that the floating caliper (22) is pulled towards the lining carrier (12). The lining carrier (12) as such is coupled in radial direction almost without clearance by the receiving eyes (14), (16) and the retaining bolts (10), (11) to the brake anchor plate (2), eliminating a radial movement.

In the case of the first construction of the brake lining (45) according to FIG. 28 it is provided that the floating caliper (22) has in the region of the underside of the cylinder (40) a projection (48), FIG. 7, which interacts in a supporting manner with a groove-shaped recess (37) in the central region (36) of the connecting web (35) of the brake anchor plate (2). The force of the spring arms (82) upon the surfaces (41) is transmitted in this construction via the projection (48) into the brake anchor plate (2).

In the case of the second construction of the brake lining (45) according to FIG. 29 the lining carrier has two further radial projections (69). The radially outer surface (70), FIG. 39, of these projections (69) is the lateral surface (71) of a cylinder, the axis (72) of which in the fitted state of the brake lining (45) coincides with, or lies at least close by, the axis (51), FIG. 20, of the cylinder of the lateral surface (50). The basic principle is that the axis (52) of the cylinder (40) of the piston (21), the axis (51) of the cylinder of the lateral surface (50) in the bridge (26), and the axis (72) of the cylinder of the lateral surface (71) of the projections (69) are to coincide.

The floating caliper (22), independently of which lining construction is to be used, may take the form of both an unmachined part and a finished part for both lining constructions. When the cylinder (40) for receiving the piston (21) is manufactured, then a part of the bridge (26) is simultaneously machined, FIG. 20, to ensure that there is sufficient room for the gaiter for the external sealing of the piston (21).

During this machining of the floating caliper (22) a lateral surface (50) is turned or milled in the inner surface (49) of the bridge (26), the axis (51) of this lateral surface (50) coinciding with the axis (52) of the cylinder (40) for receiving the piston (21).

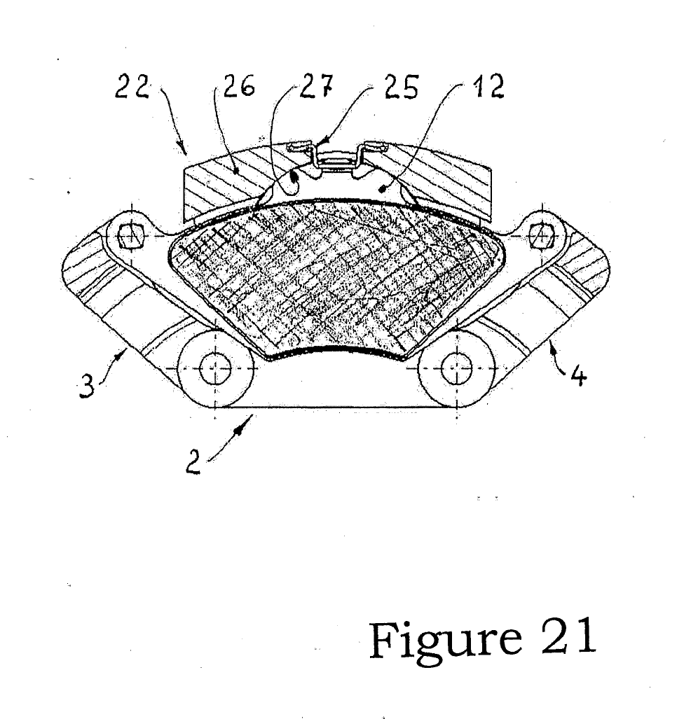

The force of the spring arms (82) upon the surfaces (41) are transmitted in this construction via the lateral surface (50) at the inner side (27), FIG. 21, of the bridge (26) of the floating caliper (22) to the projections (69) of the lining carrier (12) and from the lining carrier (12) via the retaining bolts (10), (11) into the brake anchor plate (2).

In order to ensure the supporting of the spring arms (82) and the supporting of the floating caliper (22) on the projections (69) throughout the wear of the brake linings (44), (45) as well as the permissible wear of the brake disc (43), the dimensions of the axial extent (46) of the surface (41), FIG. 5, and of the axial extent (53) of the lateral surface (50), FIG. 22, have to be selected relatively large, these dimensions being approximately in the region of 25 to 30 millimetres.

In a further embodiment it is provided that in the bottom region of the cylinder (40) an eye is provided, which forms a bearing arrangement with a guide sleeve fastened to the brake anchor plate (2). In this construction the spring forces of the inner spring (25) are then transmitted via the eye and the guide sleeve to the brake anchor plate (2). Mass acceleration forces may also be taken up by this bearing arrangement and transmitted into the brake anchor plate (2). The guide sleeve is fastened for example by means of a screw to the brake anchor plate (2). Given this type of fastening, a collar or countersunk portion that centres the guide sleeve may be provided on the brake anchor plate (2). For this construction of the brake anchor plate (2) the machining outlay is slightly greater. Nevertheless this additional machining, drilling, thread cutting, countersinking or machining of the collar may be effected in the same chucking of the brake anchor plate (2) on the machine tool, in which the bores for receiving the retaining bolts (10), (11) and the bores for receiving the fastening screws are also introduced.

FIG. 53 shows a representation of the resultant (106) of the spring force of the inner spring (25), the reaction force (108) and the force of gravity (11), the effective forces and the lever arms of the inner brake lining (44) that form the basis thereof.

The inner spring (25) via the projection (60) pulls the inner brake lining (44) in the drawing in an upward direction. The force that is summoned up by the two spring legs (82) and pulls the inner brake lining (44) upwards is to be referred to hereinafter as the resultant (106) of the spring force of the inner spring (25).

The resultant (106) acts along the action line (107). Extending at a distance (111) from the action line (197) is the reaction line (109). Here, the reaction force (108) is effective. It acts from the retaining bolts (10), (11) upon the receiving eyes (14), (16) of the lining carrier (12).

The distance between the plane (66) of the friction surface of the brake disc (43) and the plane (112) of the friction surface of the brake lining (44) is generally referred to as the brake release clearance. The brake release clearance is to arise in the non-actuated state of the disc brake (1). It lies in the order of magnitude of several hundredths of a millimetre to approximately two tenths of a millimetre.

If the brake release clearance is too great, in conventional hydraulically actuated disc brakes the pre-braking distance of the brake pedal increases and, if the brake release clearance is too small, the brake linings rub against the brake disc, thereby increasing the fuel consumption. The rubbing may moreover lead to unpleasant, annoying noises.

Upon actuation of the disc brake (1), the brake linings (44), (45) after overcoming the brake release clearance are pressed against the brake disc (43) and after release a brake release clearance arises anew. Upon actuation of the disc brake (1), the brake lining (44) aligns itself against the plane (66) of the friction surface of the brake disc (43). The radially effective forces, resultant (106), reaction force (108) and force of gravity (110) are relatively low, by quite two tenths of power, compared to the axially effective actuating force. In terms of their effect they are negligible for the actuated disc brake (1).

If however the disc brake (1) is in the non-actuated state, only the force of the piston (21) that is generated by the hydrostatic line pressure is effective in axial direction. This force is low and not capable of displacing the brake lining It is negligibly low.

On the other hand, the radially effective forces, resultant (106), reaction force (108) and force of gravity now produce a slight tilting of the brake lining (44): assuming that the point of introduction of the reaction force (108) into the receiving eyes (14), (16) is a pivot point, then the resultant (106) brings about a rotation of the brake lining (44) in clockwise direction, this having the effect that the brake lining (44) with its radially inner region facing the brake disc axis would overcome the brake release clearance and come into contact with the friction surface of the brake disc (43) in the inner region thereof.

The force of gravity (110) on the other hand brings about a rotation of the brake lining (44) in anticlockwise direction, this having the effect that the brake lining (44) with its radially outer region would overcome the brake release clearance and come into contact with the friction surface of the brake disc (43) in the outer region thereof.

The force of gravity (110) and the distance of the gravitational force line (67) from the reaction line (109) decrease markedly with increasing wear of the friction mass (18), and in the fully worn state of the brake lining (44) the gravitational force line (110) may coincide with the action line (107).

It is therefore not possible to tune the leverages and the forces to one another in such a way that the brake lining (44) remains throughout its life aligned exactly parallel to the plane (66) of the friction surface of the brake disc (43).

1. Disc brake for motor vehicles of the style of construction of a floating-caliper partially lined disc brake wherein:
a) a brake anchor plate comprises two brake anchor plate arms, one that runs in and one that runs out, each brake anchor plate arm has two receiving eyes, of which the one, an inner one, lies in the region of a screw-on plane and the other, an outer one, lies in the region of an opposite end of the brake anchor plate arm to the screw-on plane;
b) two retaining bolts are supported in the receiving eyes, the one in the inner and outer receiving eye of the running-in brake anchor plate arm, the other in the inner and outer receiving eye of the running-out brake anchor plate arm;
c) two lining carriers have thereon—viewed in a circumferential direction—ends receiving eyes, by which the two lining carriers are supported on the retaining bolts, and at the two lining carriers side remote from a friction mass through-points, of which the through-points of an outer lining carrier interact with the bridge fingers of a floating caliper in the sense of a tangential and a radial positive connection and the through-points of an inner lining carrier interact with a piston in the sense of a radial positive connection;
d) an outer spring is connected in a fixed manner to the outer lining carrier and generates an axial tensile force between the outer lining carrier and the bridge fingers of the floating caliper;
e) an inner spring generates between the inner lining carrier and the bridge of the floating caliper a radial force that pulls the lining carrier towards the inner side of the bridge of the floating caliper;
f) the floating caliper bridge fingers have recesses that receive the through-points of the outer lining carrier; and
g) damping plates are fitted on the lining carriers at the side of the lining carriers remote from the friction mass.

2. Disc brake according to claim 1, wherein the cross section of the brake anchor plate arm in the region between the inner and outer receiving eye is configured in the shape of a hollow, wherein the hollow is part of a cylinder lateral surface, and the cylinder axis coincides with, or lies at least close by, the axis of the receiving eyes.

3. Disc brake according to claim 2, wherein the brake anchor plate has a groove-shaped recess in a central region of a connecting web thereof.

4. Disc brake according to claim 1, wherein the recesses in the bridge fingers have a circular cross section.

5. Disc brake according to claim 1, wherein in a region of the connection of the bridge to a cylinder of the disc brake two planar tangentially spaced surfaces are introduced in a recessed manner relative to a bridge surface.

6. Disc brake according to claim 5, wherein a dimension of the axial extent of the two planar tangentially spaced surfaces corresponds at least to a sum of the wear dimensions of both brake linings of the disc brake and the wear dimension of a brake disc of the disc brake.

7. Disc brake according to claim 1, wherein a cylinder of the disc brake at a side remote from the bridge has a projection.

8. Disc brake according to claim 1, wherein in a region of the connection of the bridge to a cylinder of the disc brake a part of an inner surface of the bridge is a lateral surface of a cylinder, and an axis of the lateral surface of the cylinder coincides with, or lies at least close by, an axis of the cylinder.

9. Disc brake according to claim 8, wherein a dimension of an axial extent of the lateral surface corresponds at least to a sum of the wear dimensions of both brake linings of the disc brake and the wear dimension of a brake disc of the disc brake.

10. Disc brake according to claim 1, wherein the bridge fingers in an outer region have pockets.

11. Disc brake according to claim 10, wherein an inner boundary at an inlet of the pocket coincides with a pocket plane and rises in the direction of a pocket base and extends in the region of the pocket base approximately parallel to the pocket plane.

12. Disc brake according to claim 1, wherein a radial projection is formed centrally relative to the receiving eyes in a radially outer region of the lining carrier.

13. Disc brake according to claim 12, wherein a thickness of the radial projection is partially lower than a thickness of the lining carrier.

14. Disc brake according to claim 12, wherein two barbs are formed in a broad side of the radial projection.

15. Disc brake according to claim 12, wherein two grooves are formed in a broad side of the radial projection.

16. Disc brake according to claim 12, wherein a barb and a groove are formed in a broad side of the radial projection.

17. Disc brake according to claim 12 wherein the radial projection is disposed offset relative to a thickness of the lining carrier.

18. Disc brake according to claim 13, wherein the radial projection in a region of lower thickness has an undercut.

19. Disc brake according to claim 12, wherein two further radial projections are disposed in the radially outer region of the lining carrier.

20. Disc brake according to claim 19, wherein the two further radial projections extend symmetrically relative to the projection.

21. Disc brake according to claim 20, wherein the radially outer surfaces of the two projections lie on a lateral surface of a cylinder, the axis of the lateral surface of the cylinder lies on or at least close by the cylinder axis.

22. Disc brake according to claim 1, wherein the receiving eyes have a basic shape of a circle, in an outside circumference thereof bays are worked.

23. Disc brake according to claim 22, wherein the bays are distributed uniformly over the circumference.

24. Disc brake according to claim 23, wherein the uniform distribution of the bays over the circumference is effected in such a way that lining forces, which act parallel to an axis of symmetry of the lining carrier and parallel to a plane of the lining carrier, and lining forces, which act at right angles to the axis of symmetry of the lining carrier and parallel to the plane of the lining carrier, are transmitted always into regions of the outside circumference of the circle of the basic shape.

25. Disc brake according to claim 1, wherein a basic shape of a surface of the damping plate is congruent with a surface of the lining carrier.

26. Disc brake according to claim 25, wherein webs are formed out from an inner surface of receiving eyes of the damping plate.

27. Disc brake according to claim 26, wherein the webs of the damping plate fill the bays in the receiving eyes of the lining carrier.

28. Disc brake according to claim 26, wherein the webs of the damping plate fill the bays in the receiving eyes of the lining carrier with a slight oversize.

29. Disc brake according to claim 1, wherein each retaining bolt has a head on one end thereof and a groove on another end thereof.

30. Disc brake according to claim 1, wherein each retaining bolt has a groove on each end thereof.

31. Disc brake according to claim 1 wherein the inner spring has two spring legs adjoined by side walls and a bottom surface connecting the side walls, wherein the bottom surface has a cutout.

32. Disc brake according to claim 31, wherein the cutout has a rectangular basic shape, longitudinal sides thereof run parallel to longitudinal sides of the bottom surface and in a central region of each longitudinal side of the cutout a projection extends in a plane of the bottom surface towards a centre of the cutout.

33. Disc brake according to claim 32, wherein end faces of the projections extend in a slightly rounded manner in such a way that a mutual spacing of the end faces is at its lowest in the centre of the cutout.

34. Disc brake according to claim 32, wherein the projections have parallel side edges.

35. Disc brake according to claim 31, wherein the cutout has a rectangular basic shape, longitudinal sides thereof which run parallel to longitudinal sides of the bottom surface, and in one broad side thereof is a tongue-shaped projection which extends in a plane of the bottom surface towards a centre of the recess.

36. Disc brake according to claim 31, wherein the cutout has a rectangular basic shape, longitudinal sides thereof which run parallel to longitudinal sides of the bottom surface, and in each of two broad sides thereof is a tongue-shaped projection which extends in a plane of the bottom surface towards a centre of the recess.

37. Disc brake according to claim 1 wherein the outer spring has a planar base plate adjoined by side walls, towards which spring arms, which have angled end pieces adjoining their end, extend parallel to the base plate.

38. Disc brake according to claim 37, wherein the side walls, the spring arms and the end pieces of the outer spring are approximately part of a trapezium.

39. Disc brake according to claim 1, wherein the brake anchor plate is an integral component of the stub axle.

40. Method of assembling a disc brake according to claim 1 by the steps wherein:
a) outer and inner lining carriers are fastened to the brake anchor plate by means of retaining bolts;
b) the floating caliper is slipped onto the lining carriers, wherein inner boundaries of pockets of the bridge fingers engage behind and tension spring arms of the inner spring until the through-points of the outer lining carrier latch into recesses in the bridge fingers;
c) the inner lining carrier is displaced relative to piston of the disc brake until the inner lining carrier lies adjacent to the end face thereof, wherein the through-points of the inner lining carrier are then situated inside a piston skirt;
d) the inner spring is placed by a cutout provided therein onto a radial projection of the inner lining carrier;
e) the inner spring is pressed along the radial projection of the inner lining carrier until projections in a plane of a bottom surface of the inner spring latch into an undercut of the projection of the lining carrier.
